(19) United States
(12) Patent Application Publication
(10) Pub. No.: US 2014/0365199 A1
(43) Pub. Date: Dec. 11, 2014

(54) PAIRING A PHYSICAL DEVICE WITH A MODEL ELEMENT

(71) Applicant: The Mathworks, Inc., Natick, MA (US)

(72) Inventors: Pieter J. MOSTERMAN, Framingham, MA (US); David Koh, Boston, MA (US); Dimitry Markman, Acton, MA (US); Robert K. Purser, Wayland, MA (US); Dmitry Stadnik, Natick, MA (US); Justyna Zander, Framingham, MA (US)

(73) Assignee: The Mathworks, Inc., Natick, MA (US)

(21) Appl. No.: 13/962,606

(22) Filed: Aug. 8, 2013

Related U.S. Application Data
(60) Provisional application No. 61/833,751, filed on Jun. 11, 2013.

(51) Int. Cl. G06F 17/50

(52) U.S. Cl. CPC G06F 17/5009
USPC 703/20

(57) ABSTRACT

A host device may establish a connection with a physical device. The host device may receive physical device information from the physical device, based on establishing the connection with the physical device. The host device may determine, based on receiving the physical device information, a model element associated with the physical device. The host device may pair the physical device and the model element, based on determining the model element associated with the physical device.

### RELATED APPLICATION

This application claims priority under 35 U.S.C. §119 based on U.S. Provisional Patent Application No. 61/833,751 filed on Jun. 11, 2013, the content of which is incorporated by reference herein in its entirety.

### BRIEF DESCRIPTION OF THE DRAWINGS

FIG. 1 is a diagram of an overview of an example implementation described herein;

FIG. 2 is a diagram of an example environment in which system and/or methods, described herein, may be implemented;

FIG. 3 is a diagram of example components of one or more devices of FIG. 2;

FIGS. 4A-4B are flow charts of an example process for creating a pairing between a physical device and a model element;

FIGS. 5A-5D are diagrams of an example implementation relating to the example process shown in FIGS. 4A-4B;

FIG. 6 is a flow chart of an example process for utilizing a pairing between a physical device and a model element; and

FIGS. 7A-7C are diagrams of an example implementation relating to the example process shown in FIG. 6.

### DETAILED DESCRIPTION

The following detailed description of example implementations refer to the accompanying drawings. The same reference numbers in different drawings may identify the same or similar elements.

A model may include a set of model elements that, when executed on a computing device, simulates behavior of a system. The system may include a set of physical devices that correspond to portions and/or components of the system. The model elements may correspond to the physical devices and may, when executed, simulate the behavior of the physical devices and/or the system. Systems and/or methods, described herein, may enable a host device to establish a pairing between a model element, in a model, and a physical device in a system. Once a pairing is established between the physical device and the model element, the physical device may transmit data to the host device, thereby executing the model with data received from the physical device. Similarly, inputs to and/or outputs from the model element may be transmitted to the physical device and used to control a behavior of the physical device. In this way, implementations described herein may reduce the user burden of manually determining model elements, and may enhance a user experience of designing and utilizing models representing systems of physical devices.

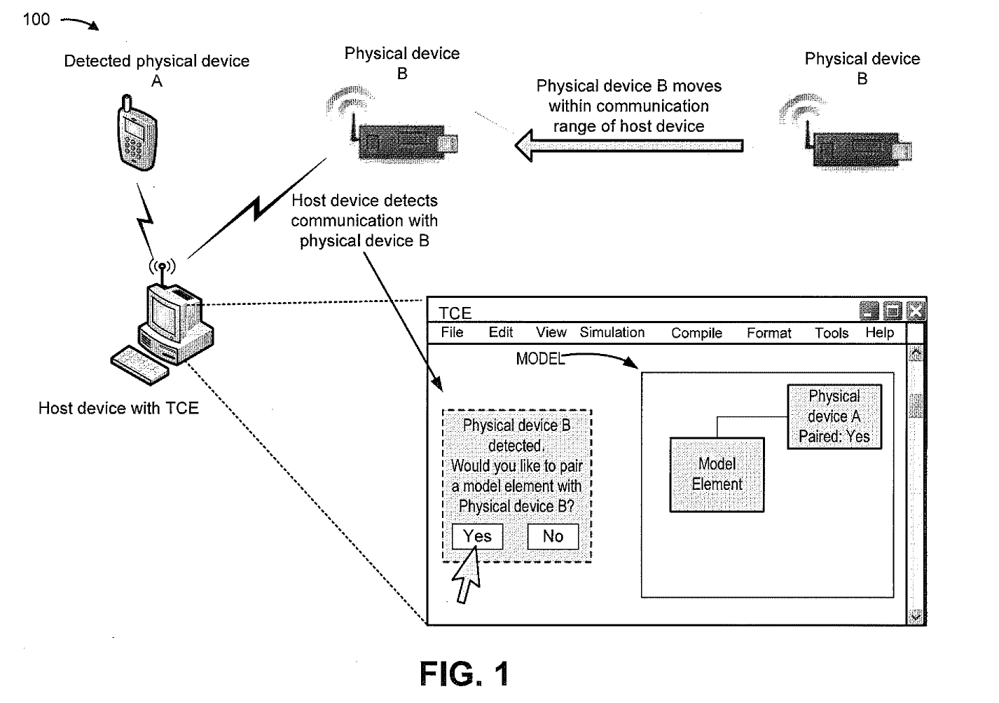

FIG. 1 is a diagram of an overview of an example implementation 100 described herein. As shown in FIG. 1, example implementation 100 may include one or more physical devices, such as a phone (shown), a mobile device, a camera, a sensor, an actuator, etc. Implementation 100 may further include a host device including a technical computing environment (TCE), such as a modeling environment. In FIG. 1, assume that the host device has detected and established communication with detected physical device A. Further assume that physical device B has moved within communication range of the host device. The host device detects that physical device B is within communication range and establishes a connection to communicate with physical device B.

As further shown in FIG. 1, the host device may provide an indication, in the TCE, that physical device B has been detected, and may further provide a request to create a model element corresponding to physical device B. The host device may receive user input to pair a model element with physical device B. For example, a user may provide input via a graphical user interface (GUI) in the TCE to indicate a decision to pair the model element with physical device B.

Pairing may include, for example, creating, adding, and/or pairing a new model element that corresponds to the physical device. Pairing may further include, for example, searching a library of model elements to identify a model element that corresponds to the physical device and/or adding a model element to the library of model elements when the physical device is not found in the library of model elements. Upon receiving the user input, the host device may add the model element to the model. Adding the model element to the model may enable the host device to employ physical device B as a data input source in the model. Similarly, inputs to and/or outputs from the model element may be transmitted to the physical device and used to control a behavior of the physical device.

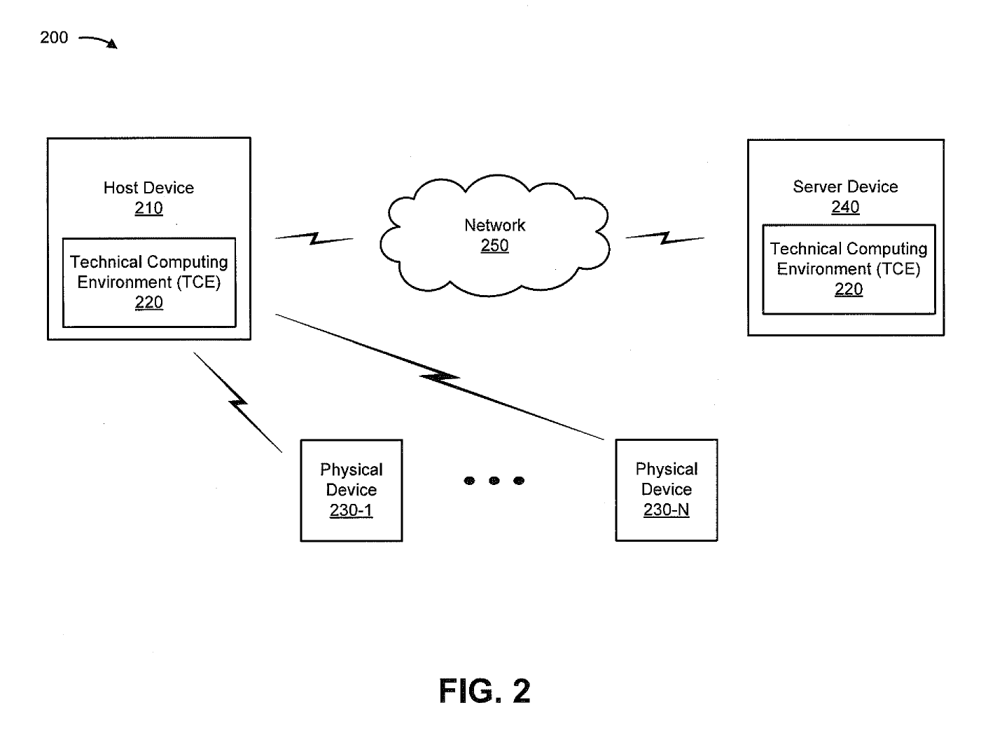

FIG. 2 is a diagram of an example environment 200 in which systems and/or methods described herein may be implemented. As shown in FIG. 2, environment 200 may include a host device 210, which may include TCE 220. Environment 200 may also include one or more physical devices 230-1 through 230-N (N≧1) (hereafter referred to individually as “physical device 230” and collectively as “physical devices 230”). Furthermore, environment 200 may include a server device 240, which may include TCE 220, and a network 250. Devices of environment 200 may interconnect via wired connections, wireless connections, or a combination of wired and wireless connections.

Host device 210 may include a device capable of receiving, generating, storing, processing, executing, and/or providing a model and/or information associated with a model (e.g., a model element, a block, an input signal, a portion of code, etc.). For example, host device 210 may include a computing device (e.g., a desktop computer, a laptop computer, a tablet computer, a handheld computer, a server, etc.) or a similar device. In some implementations, host device 210 may receive information from and/or transmit information to physical device 230 and/or server device 240 (e.g., information associated with a model and/or physical device information).

Host device 210 may host TCE 220. TCE 220 may include any hardware-based logic or a combination of hardware and software-based logic that provides a computing environment that allows tasks to be performed (e.g., by users) related to disciplines, such as, but not limited to, mathematics, science, engineering, medicine, and business. TCE 220 may include a text-based environment (e.g., MATLAB® software), a graphically-based environment (e.g., Simulink® software, Stateflow® software, SimEvents® software, Simscape® software, etc., by The MathWorks, Inc.; VisSim by Visual Solutions; LabView® by National Instruments; Agilent VEE by Agilent Technologies; Advanced Design System (ADS) by Agilent Technologies; Agilent Ptolemy by Agilent Technologies; etc.), or another type of environment, such as a hybrid environment that may include, for example, a text-based environment and a graphically-based environment. In some implementations, the TCE 220 may include, for example, a dynamically interactive user interface and/or may enable simulation and execution of hardware and/or software systems. In some implementations, TCE 220 may include a high-level architecture (HLA).

TCE 220 may be integrated with or operate in conjunction with a graphical modeling environment, which may provide graphical tools for constructing models of systems and/or processes. TCE 220 may include additional tools, such as tools designed to convert a model into an alternate representation, such as an alternate model format, code or a portion of code representing source computer code and/or compiled computer code, a hardware description (e.g., a specification of a digital circuit, a description of a circuit layout, etc.), or the like. TCE 220 may also include tools to convert a model into project files for use in an integrated development environment (IDE) such as Eclipse by Eclipse Foundation, IntelliJ IDEA by JetBrains or Visual Studio by Microsoft.

A model generated with TCE 220 may include, for example, equations (e.g., algebraic equations, differential equations, difference equations, etc.), action language, assignments, constraints, computations, algorithms, functions, methods, communication protocols, process flows, etc. The model may be implemented as, for example, time-based block diagrams (e.g., via the Simulink® product, available from The MathWorks, Incorporated), discrete-event based diagrams (e.g., via the SimEvents® product, available from The MathWorks, Incorporated), dataflow diagrams, state transition diagram (e.g., via the Stateflow® product, available from The MathWorks, Incorporated), software diagrams, a textual array-based and/or dynamically typed language (e.g., via the MATLAB® product, available from The MathWorks, Incorporated), noncausal block diagrams (e.g., via the Simscape™ product, available from The MathWorks, Incorporated), and/or another type of model.

A model may include one or more model elements that simulate characteristics of physical devices, such as physical devices 230. A model element may correspond to physical device 230 and may implement, in the model, data specifications, processing functions, and/or input/output connections that are representative of physical device 230. While some implementations are described herein with respect to a model element representing a physical device (e.g., physical device 230), the model element may represent physical device 230 and/or a component, subsystem, etc. of physical device 230.

The system and/or physical device 230 represented by a model may have various execution semantics that may be represented in the model as a collection of modeling entities, often referred to as blocks. A block may generally refer to a portion of functionality that may be used in the model. The block may be represented graphically, textually, and/or stored in some form of internal representation. Also, a particular visual depiction used to represent the block, for example in a graphical block diagram, may be a design choice. A block may be hierarchical in that the block itself may comprise one or more blocks that make up the block.

A graphical model (e.g., a functional model) may include entities with relationships between the entities, and the relationships and/or the entities may have attributes associated with them. The graphical entities may represent time-based dynamic systems, such as differential equation systems. In some embodiments, the graphical model and the graphical entities may represent a multi-domain dynamic system. The domains may include execution domains such as, for example, continuous time, discrete time, discrete event, state transition system, and/or a model of computation. The model of computation may be based on differential equations, difference equations, algebraic equations, discrete events, discrete states, stochastic relations, data flows, synchronous data flows, control flows, process networks, and/or state machines.

The entities my include model elements, such as blocks and/or ports. The relationships may include model elements, such as lines (e.g., connector lines) and references. The attributes may include model elements, such as value information and meta information for the model element associated with the attributes. A graphical model may be associated with configuration information. The configuration information may include information for the graphical model, such as model execution information (e.g., numerical integration schemes, fundamental execution period, etc.), model diagnostic information (e.g., whether an algebraic loop should be considered an error or result in a warning), model optimization information (e.g., whether model elements should share memory during execution), model processing information (e.g., whether common functionality should be shared in code that is generated for a model), etc.

Additionally, or alternatively, a graphical model may have executable semantics and/or may be executable. An executable graphical model may be a time based block diagram. A time based block diagram may consist, for example, of blocks connected by lines (e.g., connector lines). The blocks may consist of elemental dynamic systems such as a differential equation system (e.g., to specify continuous-time behavior), a difference equation system (e.g., to specify discrete-time behavior), an algebraic equation system (e.g., to specify constraints), a state transition system (e.g., to specify finite state machine behavior), an event based system (e.g., to specify discrete event behavior), etc. The lines may represent signals (e.g., to specify input/output relations between blocks or to specify execution dependencies between blocks), variables (e.g., to specify information shared between blocks), physical connections (e.g., to specify electrical wires, pipes with volume flow, rigid mechanical connections, etc.), etc. The attributes may consist of meta information such as sample times, dimensions, complexity (whether there is an imaginary component to a value), data type, etc. associated with the model elements.

In a time based block diagram, ports may be associated with blocks. A relationship between two ports may be created by connecting a line (e.g., a connector line) between the two ports. Lines may also, or alternatively, be connected to other lines, for example by creating branch points. For instance, three or more ports can be connected by connecting a line to each of the ports, and by connecting each of the lines to a common branch point for all of the lines. A common branch point for the lines that represent physical connections may be a dynamic system (e.g., by summing all variables of a certain type to 0 or by equating all variables of a certain type). A port may be an input port, an output port, an enable port, a trigger port, a function-call port, a publish port, a subscribe port, an exception port, an error port, a physics port, an entity flow port, a data flow port, a control flow port, etc.

Relationships between blocks may be causal and/or non-causal. For example, a model (e.g., a functional model) may include a block that represents a continuous-time integration block that may be causally related to a data logging block by using a line (e.g., a connector line) to connect an output port of the continuous-time integration block to an input port of the data logging block. Further, during execution of the model, the value stored by the continuous-time integrator may change as the current time of the execution progresses. The value of the state of the continuous-time integrator may be available on the output port and the connection with the input port of the data logging block may make this value available to the data logging block.

Physical device 230 may communicate with host device 210 and may include one or more physical devices capable of receiving, generating, storing, processing, and/or providing physical device information describing and/or associated with physical device 230. For example, physical device 230 may include a system and/or subsystem, such as a computing device, a mobile phone, a smart phone, a camera, a camcorder, a microphone, a video display, a robot, or the like. Additionally, or alternatively, physical device 230 may include a component of a system and/or subsystem, such as a sensor, an actuator, a motor, an accelerometer, a gyroscope, a measurement device, an input component, an output component, a processing component, a video processor, a transmitter, or the like. Physical device 230 may include a combination of a system, a subsystem, and/or a component, in some implementations. Physical device 230 may communicate with host device 210 using wired and/or wireless connections to exchange physical device information. Physical device 230 may be modeled using TCE 220.

Server device 240 may include one or more devices capable of receiving, generating, storing, processing, executing, and/or providing a model and/or information associated with a model (e.g., information associated with a model element). For example, server device 240 may include a computing device, such as a server, a desktop computer, a laptop computer, a tablet computer, a handheld computer, or a similar device. In some implementations, server device 240 may host TCE 220.

Network 250 may include one or more wired and/or wireless networks. For example, network 250 may include a cellular network, a public land mobile network (PLMN), a local area network (LAN), a wide area network (WAN), a metropolitan area network (MAN), a telephone network (e.g., the Public Switched Telephone Network (PSTN)), a near-field communication network, a Bluetooth network, an ad hoc network, an intranet, the Internet, a fiber optic-based network, and/or a combination of these or other types of networks. Network 250 may include configurations of host device(s) 210 and physical device(s) 230 utilizing technology to automatically create a network based on the internet protocol suite (TCP/IP). Bonjour by Apple and Avahi are examples of “zero-configuration” network technologies that may automatically create network 250.

The number of devices and networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

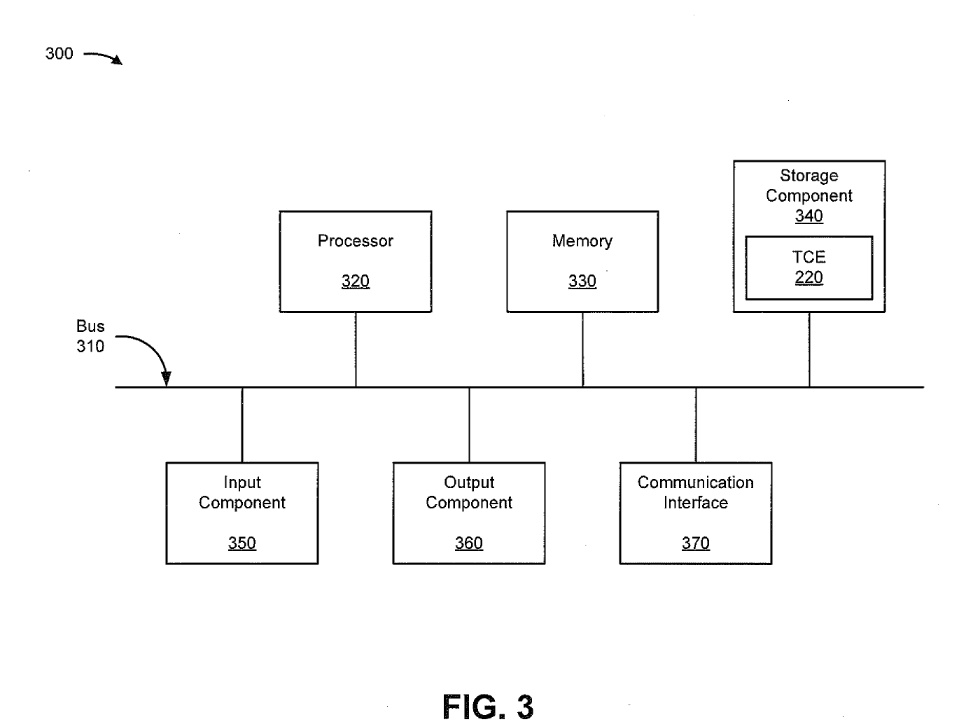

FIG. 3 is a diagram of example components of a device 300, which may correspond to host device 210, physical device 230, and/or server device 240. In some implementations, each of host device 210, physical device 230, and/or server device 240 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a mechanism that permits communication among the components of device 300. Processor 320 may include a processing unit (e.g., a central processing unit, a graphics processing unit, an accelerated processing unit, etc.), a microprocessor, and/or any processing component (e.g., a programmable logic unit or device, a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage component (e.g., a flash, magnetic, or optical memory) that stores information and/or instructions for use by processor 320.

Storage component 340 may store information and/or software, in a machine/computer-readable format, related to the operation and use of device 300. For example, storage component 340 may include a hard disk (e.g., a magnetic disk, an optical disk, a magneto-optic disk, a solid state disk, etc.), a compact disk (CD), a digital versatile disk (DVD), a floppy disk, a cartridge, a memory card, a magnetic tape, and/or another type of computer-readable medium, along with a corresponding drive. In some implementations, storage component 340 may store TCE 220.

Input component 350 may include a component that permits a user to input information to device 300 (e.g., a touch screen display, a keyboard, a keypad, a mouse, a button, a switch, etc.). Output component 360 may include a component that outputs information from device 300 (e.g., a display, a speaker, one or more light-emitting diodes (LEDs), etc.).

Communication interface 370 may include a transceiver-like component, such as a transceiver and/or a separate receiver and transmitter that enables device 300 to communicate with other devices, such as via a wired connection, a wireless connection, or a combination of wired and wireless connections. For example, communication interface 370 may include an Ethernet interface, an optical interface, a coaxial interface, a wireless network interface controller, an infrared interface, a radio frequency (RF) interface, a universal serial bus (USB) interface, or the like.

Device 300 may perform one or more processes described herein. Device 300 may perform these processes in response to processor 320 executing software instructions included in a computer-readable medium, such as memory 330 and/or storage component 340. A computer-readable medium may be defined as a non-transitory memory device. A memory device may include memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided as an example. In practice, device 300 may include additional components, fewer components, different components, or differently arranged components than those shown in FIG. 3. For example, physical device 230 may not include TCE 220. Additionally, or alternatively, one or more components of device 300 may perform one or more functions described as being performed by another one or more components of device 300.

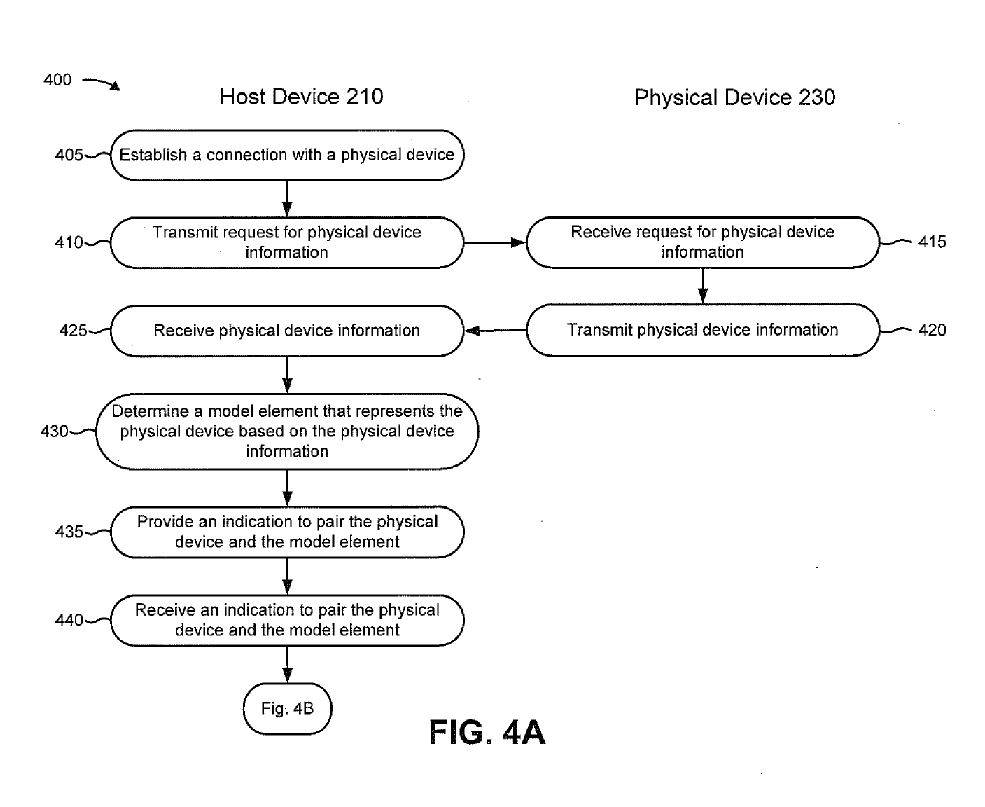

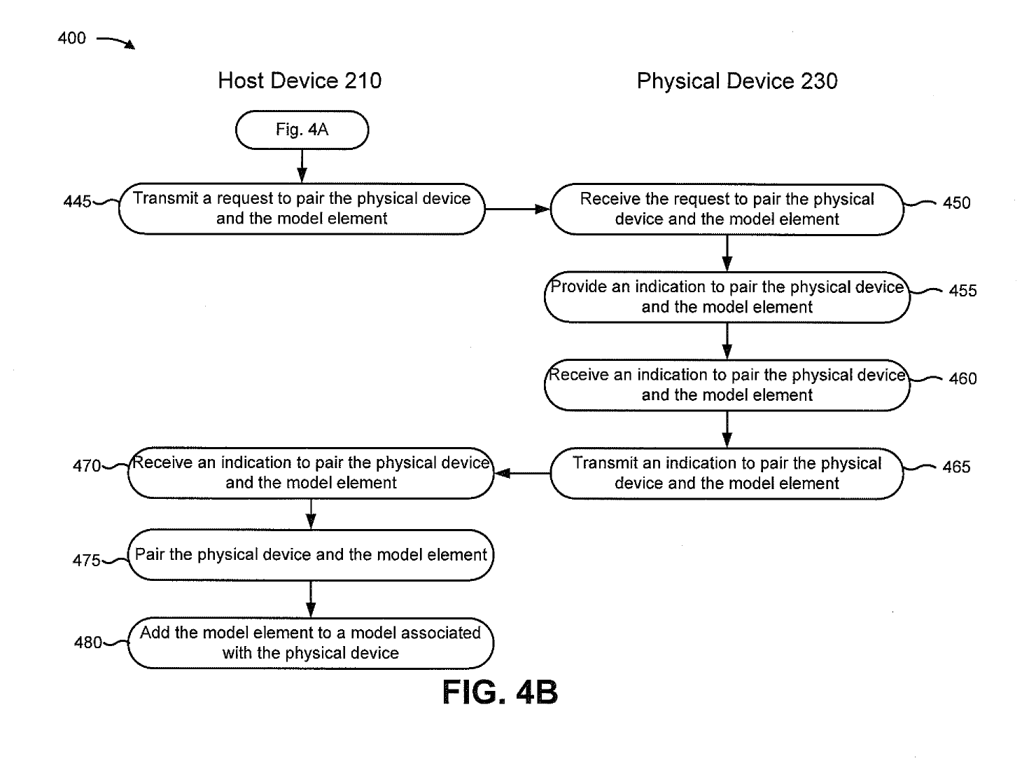

FIGS. 4A-4B are flow charts illustrating exemplary processing for creating a pairing between a physical device and a model element. In some implementations, one or more process blocks of FIGS. 4A-4B may be performed by host device 210 and physical device 230. In some implementations, one or more process blocks of FIGS. 4A-4B may be performed by another device or a group of devices separate from or including host device 210 and physical device 230, such as server device 240.

As shown in FIG. 4A, process 400 may include establishing a connection with a physical device (block 405). For example, host device 210 may establish a connection with physical device 230. Host device 210 may detect the presence of physical device 230 via a wired interface connection, and may establish the connection to physical device 230 using the wired interface connection. Examples of wired interface connections may include a universal serial bus (USB) connection, a parallel or serial bus connection, a coaxial connection, an optical connection, or the like. Additionally, or alternatively, host device 210 may detect the presence of physical device 230 via a wireless interface, and may establish the connection to physical device 230 using the wireless interface. Wireless interface connections may be made using radio, microwave, and/or infrared transmissions, in some implementations. Examples of specific technologies employing wireless interface connections include Wi-Fi, wireless USB, Bluetooth technology, ZigBee or the like.

As further shown in FIG. 4A, process 400 may include transmitting a request for physical device information (block 410). For example, host device 210 may transmit a request, for physical device information, to physical device 230. The request may be transmitted one or more times to physical device 230. In some implementations, host device 210 may transmit the request in a manner in which the connection was established between host device 210 and physical device 230 (e.g., a wired or wireless connection).

Physical device information may include device-specific information that may be used to identify, configure, and/or utilize physical device 230 in TCE 220. In some implementations, physical device information may include a physical device driver (e.g., a computer program or code), a physical device identifier (e.g., a serial number, address, device name, etc.), information associated with an input and/or an output of physical device 230 (e.g., a quantity of input/output ports, a type and/or value of information received via an input port, a type and/or value of information transmitted via an output port, a data type of information associated with input/output ports, a size of the dimension of information associated with input/output ports, a number of dimensions of information associated with input/output ports, etc.), an accuracy of information associated with physical device 230, encoding values associated with physical device 230 (e.g., red-green-blue (RGB) values, hue-saturation-lightness (HSL) values, etc.), or the like.

Additionally, or alternatively, physical device information may include information identifying a sample rate associated with physical device 230, interface definitions necessary to program a communication interface with physical device 230, a unique identifier associated with a model element representing physical device 230, a device driver identifier, physical, electrical, software, and/or mechanical specifications necessary to configure physical device 230 with host device 210, or the like. Additionally, or alternatively, physical device information may include information identifying a location where physical device information can be found (e.g., a web site, a memory location, etc.), information identifying a type of signal received and/or transmitted by physical device 230, information identifying other physical devices 230 that physical device 230 is in communication with, or the like. In some implementations, physical device information may include location information associated with physical device 230 (e.g., a geo-location of physical device 230, which may be determined using global positioning system (GPS) information).

Additionally, or alternatively, physical device information may further include component-specific information used to identify, configure, and/or utilize a component within physical device 230. For example, physical device 230 may include a laptop computer comprising a component associated with recording audio signals and/or a component to perform processing of the audio signal. The physical device information may include information regarding the component (e.g., information described above in connection with physical device 230).

In some implementations, host device 210 may specify a type of physical device information requested from physical device 230. Additionally, or alternatively, host device 210 may determine a type of model and/or model element, and may transmit a request for physical device information pertaining to the determined model and/or model element.

Additionally, or alternatively, physical device information may include information containing cryptographic or encryption data enabling secure access and usage of physical devices 230. For example, physical device 230 may transmit physical device information requiring a user to employ digital signature protocols to further utilize a model element representing physical device 230.

As further shown in FIG. 4A, process 400 may include receiving a request for physical device information (block 415), and transmitting physical device information (block 420). For example, physical device 230 may receive a request for physical device information from host device 210. Physical device 230 may process the request, and may transmit physical device information to host device 210 based on processing the request. In some implementations, physical device 230 may transmit physical device information in a manner in which the connection was established between host device 210 and physical device 230 (e.g., a wired or wireless connection) and/or may transmit the information via a different connection.

As further shown in FIG. 4A, process 400 may include receiving the physical device information (block 425). For example, host device 210 may receive physical device information transmitted from physical device 230. In some implementations, host device 210 may receive a specified type of physical device information based on the response to the request transmitted by host device 210. For example, host device 210 may request a particular type of physical device information from physical device 230, and physical device 230 may respond to the request by providing the requested type of physical device information to host device 210.

As further shown in FIG. 4A, process 400 may include determining a model element that represents physical device 230 based on the physical device information (block 430). For example, host device 210 may determine a model element that represents the physical device based on the physical device information received from physical device 230. In some implementations, host device 210 may receive physical device information that may include a device driver and/or information identifying a device driver (e.g., information that may be used by host device 210 to retrieve the device driver from the internet, from another device, etc.). Host device 210 may determine the model element based on the device driver representing physical device 230.

A model element corresponding to physical device 230 may, when executed, simulate the behavior of physical device 230 and/or a system that includes physical device 230. Additionally, or alternatively, a model element may facilitate an exchange of data between a model and physical device 230. For example, a model element may provide the output values of physical device 230 as input values to a model being designed or executed using TCE 220. In some implementations, a model element may provide output values of a model as input values to physical device 230. For example, a model element representing physical device 230 may use a device driver associated with physical device 230 to provide output values of a model as input values to physical device 230.

In some implementations, a model element may include program code (e.g., in a textual format), a graphical feature (e.g., in a graphical format), a hybrid model element (e.g., including both program code and graphical features), or a similar model element that, when executed, may perform one or more computing tasks or operations. A model element may represent a specific physical device 230 and/or may represent a specific function performed by physical device 230 to accomplish the one or more computing tasks. For example, a model element may include a portion of program code (e.g., a code block, a function, a method, a variable, etc.), a block in a graphical model, a block parameter, a block interface (e.g., a port, a signal, etc.), an object in a workspace (e.g., a workspace of TCE 220), or the like. Additionally, or alternatively, a model element may represent a component of physical device 230. For example, if physical device 230 is a laptop computer, then a model element may represent a microphone, a camera, a touchpad, etc. of the laptop computer.

In some implementations, host device 210 may determine the model element representing physical device 230 by comparing the physical device information to information associated with a library of available model elements. Host device 210 may identify a corresponding model element appropriate for representing physical device 230 based on the physical device information. The library of model elements may be stored on host device 210, physical device 230, and/or server device 240. For example, physical device information may identify physical device 230 as a particular type of physical device (e.g., a video recorder) and/or including a particular number of output ports. Host device 210 may determine a model element that represents the particular type of device that includes the particular number of output ports. In some implementations, host device 210 may add a model element representing physical device 230 to the library of model elements. For example, a user may be prompted to add a model element to the list of model elements stored in the library when host device 210 is unable to determine a model element representing physical device 230.

In some implementations, host device 210 may generate the model element as a new model element based on the physical device information received by host device 210. For example, host device 210 may determine that a model element representing a microphone requires an input signal, an audio processing element, and/or an output signal based on the physical device information received from physical device 230. Host device 210 may generate a new model element representing the microphone (e.g., an input from the microphone). The newly generated model element may possess the corresponding characteristics of the microphone (e.g., an input signal, an audio processing element, and/or an output signal) based on the physical device information received from physical device 230.

In some implementations, host device 210 may identify a model element using an identifier assigned to the model element based on a previous pairing between physical device 230 and host device 210. For example, host device 210 may receive physical device information including an identifier (e.g., ID: 123) that correlates physical device 230 to a model element having a matching identifier, 123, that is stored in memory based on a previous pairing between host device 210 and a physical device similar to or the same as physical device 230. Host device 210 may determine a model element for physical device 230 based on the matching identifier.

In some implementations, host device 210 may determine the model element based on input received from a user. For example, upon receiving physical device information from physical device 230, host device 210 may provide the user with a GUI listing available model elements corresponding to physical device 230. Host device 210 may receive user input, selecting a model element, and may determine the appropriate model element based on the user input (e.g., based on the selected model element).

In some implementations, host device 210 may determine the model element based on a class of physical devices 230 previously connected to host device 210 when the current connected physical device 230 is a member of that class of physical devices 230. For example, host device 210 may receive physical device information from physical device 230 indicating that physical device 230 is a member of a class of devices that require a model element possessing a video processing unit, but without specifying how many input and output ports the model element should possess. Host device 210 may determine that previous physical devices 230 connected to host device 210 were paired to a model element having a video processing unit, and further having two input ports and one output port. Host device 210 may determine the appropriate model element based on the class of physical device 230 (e.g., the model element with a video processing unit, two input ports, and one output port).

In some implementations, a user may provide input to identify a model element, and may provide further input to identify physical device 230 to which the model element is to be paired. For example, the user may right-click on a model element, and host device 210 may provide a list of detected physical devices 230 (e.g., physical devices 230 which host device 210 has detected are within communication range, physical devices 230 with which host device 210 has established and/or is able to establish a connection). The user may select a physical device 230, from the list, with which the model element is to be paired. In some implementations, a user may provide input to identify a model element associated with physical device 230 when a new or more recent version of physical device 230 is to be paired with the model element. For example, a user may provide input to select or create a model element when a new or subsequent version of physical device 230 is present to establish a connection.

As further shown in FIG. 4A, process 400 may include providing an indication to pair the physical device and the model element (block 435). For example, host device 210 may provide, via TCE 220, an indication to pair physical device 230 and the model element (e.g., a pairing indicator). In some implementations, host device 210 may provide the pairing indicator via a GUI to indicate pairing physical device 230 and the corresponding model element. In a graphical modeling environment, host device 210 may provide the pairing indicator as a representation of a block that is not fully operational. Host device 210 may represent the block in a manner that differentiates the block from operational blocks, such as graying out or displaying the block as a ghost image (e.g., partially transparent) of the model element to be paired. In some implementations, host device 210 may indicate the availability of the model element as a block that can be dragged into the model. For example, host device 210 may determine a model element corresponding to physical device 230, and may provide (e.g., via TCE 220) a representation of a block which the user can drag into the model and place where appropriate (e.g., to connect to other model elements).

Additionally, or alternatively, in a textual modeling environment, host device 210 may provide the pairing indicator by inserting a portion of code into a program representing the model, or by including an additional parameter value in a line of code included in the model. For example, host device 210 may determine that the model element corresponding to physical device 230 is a block of code providing necessary parameters, functions, and/or values to simulate physical device 230 in the model. Host device 210 may insert the block of code into the model along with the pairing indicator. In some implementations, host device 210 may provide the pairing indicator in a hybrid format comprised of textual (e.g., a block of code) and graphical features (e.g., an image or icon). For example, the pairing indicator may be provided by inserting a block of code into the model and presenting an image of physical device 230 so the user knows the block of code represents functionality of physical device 230.

In some implementations, host device 210 may determine that the model element, corresponding to physical device 230, includes a block of code providing an output value of physical device 230 to the model. Additionally, or alternatively, host device 210 may determine that the model element, corresponding to physical device 230, includes a block of code providing an output value of the model as an input value to physical device 230. Host device 210 may insert the block of code into the model along with an indication to pair physical device 230 and the model element. Additionally, or alternatively, a GUI may appear in a text editor component of the textual modeling environment providing the user with the indication. For example, in a textual modeling environment, host device 210 may provide the indication via a GUI, shown within a text editing component of TCE 220, which provides a user with an indication that a block of code inserted into the model is related to pairing the model element and physical device 230.

In some implementations, host device 210 may provide an indication to pair physical device 230 and the model element by producing a visible indication (e.g., intermittently flashing an icon, varying an intensity of a border, illuminating a light-emitting diode (e.g., LED), etc.) on host device 210 to alert a user of the indication to pair. In some implementations, host device 210 may provide an indication to pair physical device 230 and the model element by producing an audible indication (e.g., a sound, a series of sounds, etc.) on host device 210 to alert a user of the indication to pair. In some implementations, host device 210 may provide an indication to pair physical device 230 and the model element by producing a haptic and/or tactile indication (e.g., a vibration, a series of vibrations, etc.) on host device 210 to alert a user of the indication to pair.

In some implementations, the type of indication provided by host device 210 may be configurable. For example, if physical device 230 was previously connected to a model element and the connection was not maintained, host device 210 may be configured to provide a unique indication to alert a user that physical device 230 is re-establishing a connection. Additionally, or alternatively, host device 210 may be configured to provide a unique indicator for a particular class or type of physical device 230. For example, host device 210 may emit a visual indication when physical device 230 (e.g., a test and measurement device) has transmitted physical device information and host device 210 has determined a model element representing physical device 230 (e.g., the test and measurement device).

As further shown in FIG. 4A, process 400 may include receiving an indication to pair the physical device and the model element (block 440). For example, host device 210 may receive (e.g., from a user) an indication to pair physical device 230 and the model element (e.g., a pairing indicator). In some implementations, host device 210 may receive the pairing indicator via user input on a GUI shown in the model or elsewhere in TCE 220. Additionally, or alternatively, the pairing indicator may be received by dragging the model element into the model. In some implementations, such as in a textual modeling implementation, host device 210 may receive a pairing indicator as input of a parameter value or the addition of a portion of code to a program representing the model. Similarly, host device 210 may receive the pairing indicator by user input of a selection shown in a GUI.

As shown in FIG. 4B, process 400 may include transmitting a request to pair the physical device and the model element (block 445). For example, host device 210 may transmit a request, to physical device 230, to pair physical device 230 and the model element (e.g., a pairing request). In some implementations, host device 210 may transmit the pairing request in a manner in which the connection was established between host device 210 and physical device 230 (e.g., a wired or wireless connection).

As further shown in FIG. 4B, process 400 may include receiving the request to pair the physical device and the model element (block 450). For example, physical device 230 may receive, from host device 210, the request to pair the physical device and the model element (e.g., a pairing request).

As further shown in FIG. 4B, process 400 may include providing an indication to pair the physical device and the model element (block 455). For example, physical device 230 may provide an indication to pair physical device 230 and the model element (e.g., a pairing indicator). In some implementations, the pairing indicator may be provided on a display of physical device 230. Additionally, or alternatively, physical device 230 may provide the pairing indicator by producing a visible indication on physical device 230. In some implementations, physical device 230 may provide the pairing indicator by producing an audible indication on physical device 230. In some implementations, physical device 230 may provide the pairing indicator by producing a haptic and/or tactile indication on physical device 230.

As further shown in FIG. 4B, process 400 may include receiving an indication to pair the physical device and the model element (block 460). For example, physical device 230 may receive an indication to pair physical device 230 and the model element based on a user interaction with physical device 230 (e.g., a pairing indicator). In some implementations, physical device 230 may receive the pairing indicator based on a user interaction with a GUI. In some implementations, physical device 230 may receive the pairing indicator via input component 350. Additionally, or alternatively, physical device 230 may receive the pairing indicator when a user manipulates the device via haptic and/or tactile means (e.g., by tilting, shaking, positioning, etc.).

For example, physical device 230 may be a gyroscope, and may receive the pairing indicator when a user manipulates the gyroscope in a single plane or multi-dimensional planes, such as rotating the gyroscope 90 degrees along a vertical axis of the gyroscope. In some implementations, physical device 230 may receive the pairing indicator through a user's input of one more spoken words. Additionally, or alternatively, physical device 230 may receive the pairing indicator from a user's input of text.

In some implementations, physical device 230 may receive indication to pair the physical device and the model element as a response to a cryptographic or authentication challenge in a security protocol necessary to access and use physical device 230. For example, physical device 230 may receive an indication to pair physical device 230 and the model element by a user who inputs a passcode in a digital signature protocol protecting usage of physical device 230. Additionally, or alternatively, host device 210 may generate a passcode and show this to the user on host device 210, where the passcode (e.g., an alphanumeric passcode, a gesture, a particular haptic input, tactile input, or the like etc.,) is to be entered on physical device 230 to complete pairing.

As further shown in FIG. 4B, process 400 may include transmitting an indication to pair the physical device and the model element (block 465). For example, physical device 230 may transmit an indication, to host device 210, to pair physical device 230 and the model element. In some implementations, physical device 230 may transmit the indication to pair in a manner in which the connection was established between host device 210 and physical device 230 (e.g., a wired or wireless connection).

As further shown in FIG. 4B, process 400 may include receiving the indication to pair the physical device and the model element (block 470), and pairing the physical device and the model element (block 475). For example, host device 210 may receive the indication to pair, transmitted by physical device 230. Once an indication to pair physical device 230 and a model element is received, host device 210 may pair physical device 230 and the model element.

In some implementations, host device 210 may pair physical device 230 and the model element based on related user input received via host device 210 and physical device 230. For example, the user may select a model element via a user interface of host device 210, and may interact with physical device 230 (e.g., by tilting, shaking, etc. physical device 230). In some implementations, host device 210 may receive an indication to pair the physical device and the model element as a response to a cryptographic or authentication challenge in a security protocol necessary to access and use physical device 230. For example, physical device 230 may generate a passcode and show this to the user on physical device 230, where the passcode (e.g., an alphanumeric passcode, a gesture, a particular haptic input, or the like etc.,) is to be entered on host device 210 to complete pairing.

Additionally, or alternatively, host device 210 may determine that the user input with the model element and physical device 230 are related (e.g., occur within a threshold period of time), and may pair the model element and physical device 230.

Host device 210 may pair physical device 230 and the model element by storing an indication of an association between physical device 230 and the model element (e.g., an association indicator). Host device 210 may store the association indicator in memory on host device 210 and/or on server device 240 (e.g., in a table, a list, a data structure, a library, etc.). Pairing may occur as a result of input to host device 210 only, as a result of input to physical device 230 only, as a result of input to both host device 210 and physical device 230, or automatically, without user input to host device 210 or physical device 230.

As further shown in FIG. 4B, process 400 may include adding the model element to a model associated with the physical device (block 480). For example, host device 210 may add a model element associated with physical device 230 to a model. Additionally, or alternatively, host device 210 may add a model element independent of a model representing physical device 230 and/or associated with physical device 230. The model may represent physical device 230 and/or may represent a system that includes physical device 230 as a model element. For example, host device 210 may create a model element representing physical device 230 when there is not a model associated with physical device 230. In some implementations, host device 210 may add the model element in a format that is awaiting further interaction to finalize the connections of the model element in the model. In some implementations, adding the model element to the model may instantiate the model element in a form or representation by which a user can add the model element to the model. Additionally, or alternatively, host device 210 may create the model element directly in the model with or without connections to other model elements. In some implementations, adding the model element to the model may further add that model element to a library of stored model elements available to host device 210.

In some implementations, adding a model element to the model may include inserting a line of code into a model. In some implementations, a model element may be automatically added to a model after host device 210 and physical device 230 re-establish a connection and pairing after the connection and pairing were not maintained (e.g., for a particular amount of time that satisfies a threshold). Additionally, or alternatively, in a textual modeling environment, adding the model element to a model may provide a user with a code portion in a text editor of TCE 220. The addition of the model element associated with physical device 230 in a model may be performed based on the indication to pair received from host device 210, from physical device 230, from both host device 210 and physical device 230, or from no indication in the event the model element may be automatically added.

The addition of the model element associated with physical device 230 may automatically activate a model element in TCE 220. For example, host device 210 may add a model element associated with a sensor to a model. Adding the model element associated with the sensor may activate a variety of graphical or textual features in TCE 220. For example, adding a model element may automatically activate an element in a library list, a variable in a workspace, an item in a GUI menu, or the like, without requiring further input from the user.

Although FIGS. 4A-4B show example blocks of process 400, in some implementations, process 400 may include additional blocks, different blocks, fewer blocks, or differently arranged blocks than those depicted in FIGS. 4A-4B. Additionally, or alternatively, one or more of the blocks of process 400 may be performed in parallel.

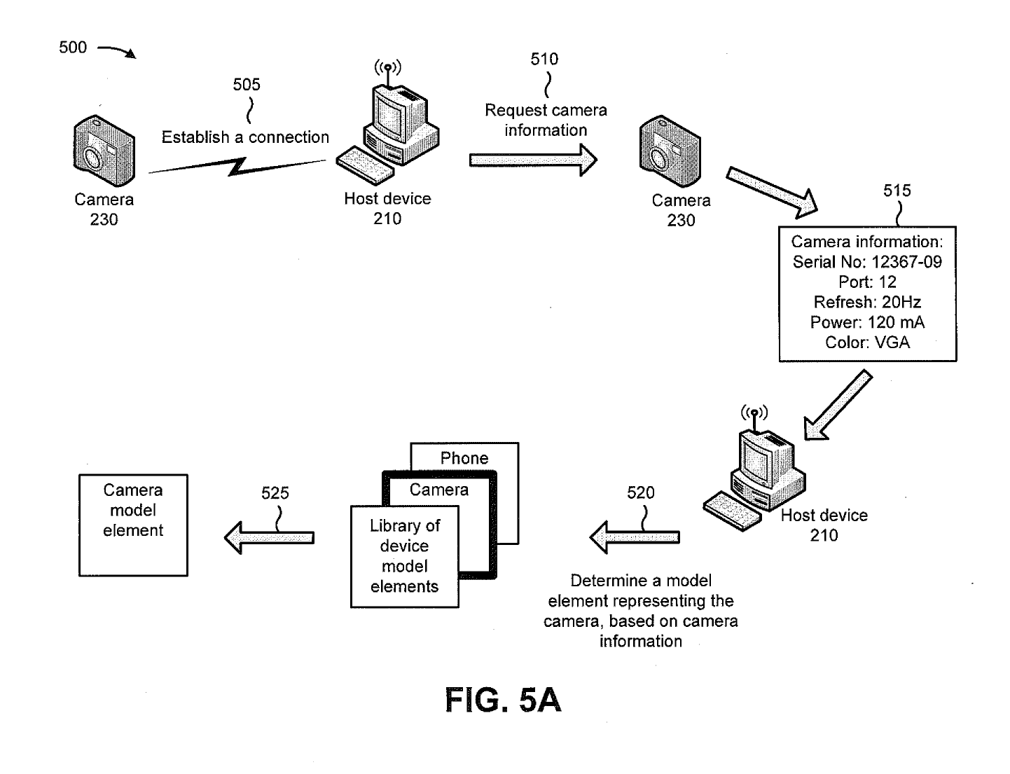

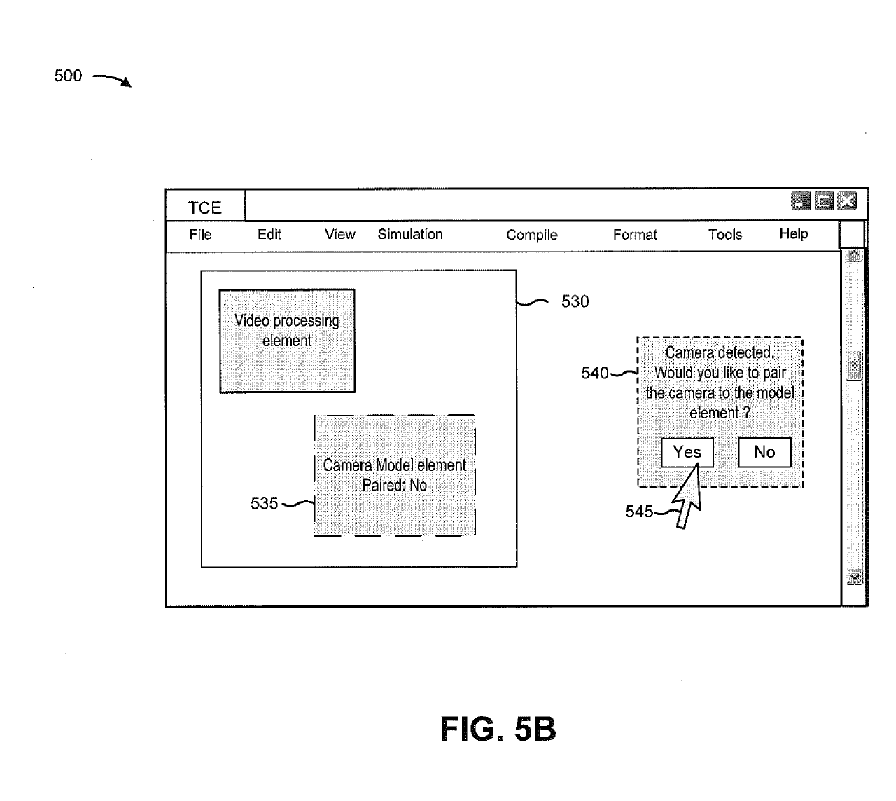

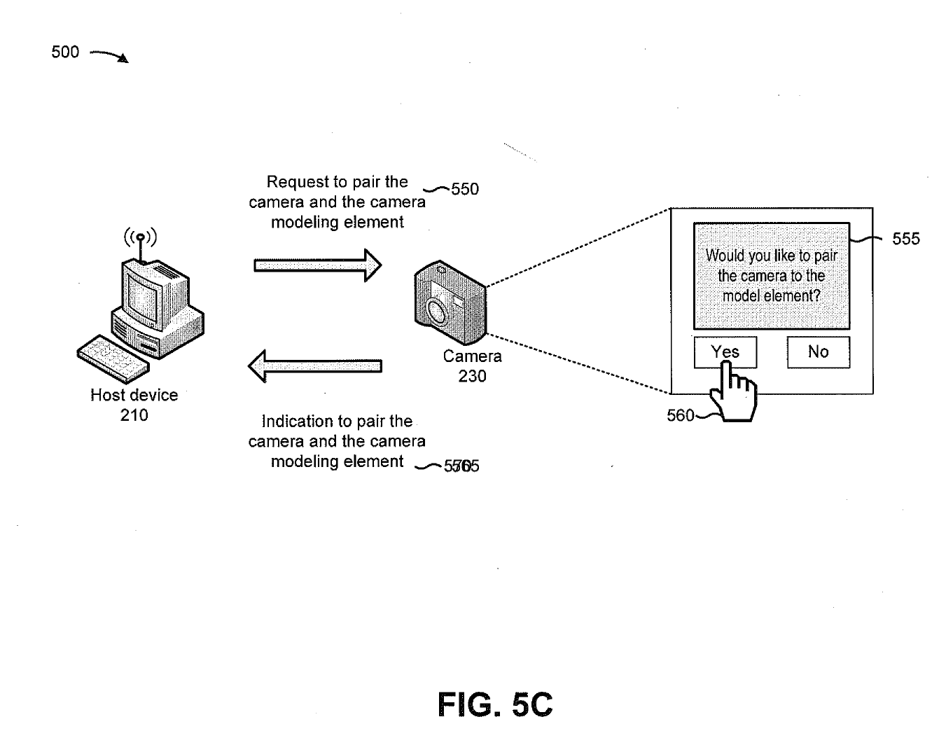

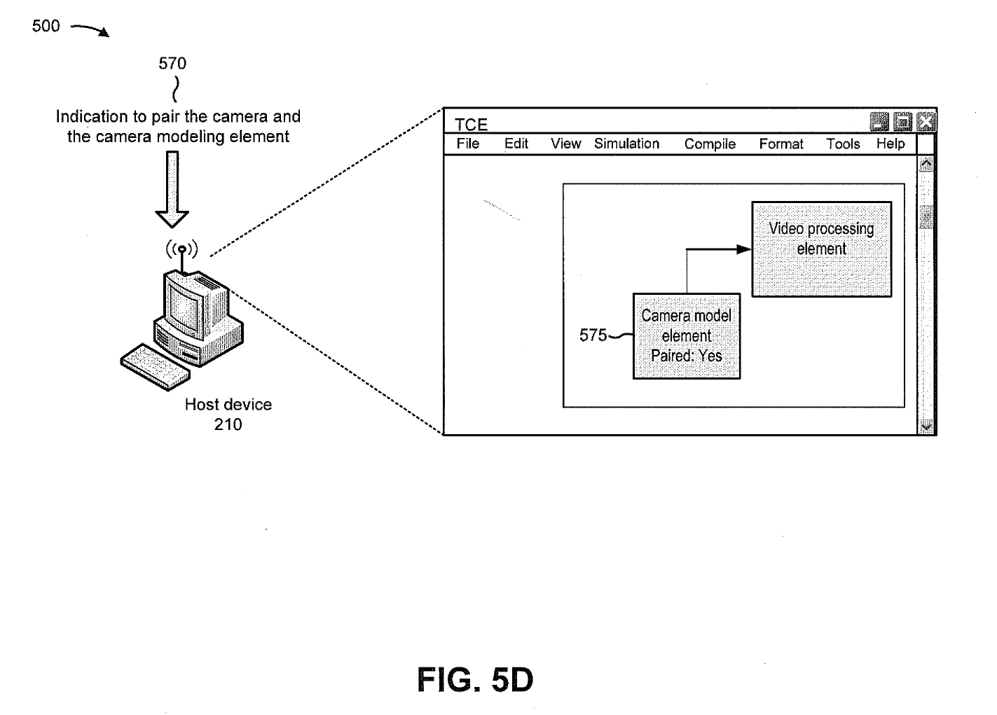

FIGS. 5A-5D are diagrams of an example implementation 500 relating to example process 400 shown in FIGS. 4A-4B. As shown in FIG. 5A, assume that camera 230 is moved into range of host device 210. As shown by reference number 505, host device 210 establishes a connection with camera 230. As shown by reference number 510, host device 210 transmits a request for physical device information to camera 230. As shown by reference number 515, upon receiving the request for physical device information, camera 230 transmits physical device information to host device 210. For example, the physical device information may include a device serial number, a data output port, a refresh rate, a power requirement, and a color output type.

As shown by reference number 520, upon receipt of the physical device information transmitted by camera 230, host device 210 determines a modeling element representing camera device 230 based on the physical device information. As shown by reference number 525, host device 210 compares the physical device information with a library of available model elements and identifies a camera model element to represent camera 230. For example, host device 210 may determine a camera type based on the serial number, and may identify the camera model element based on the camera type.

As shown in FIG. 5B, and by reference number 530, TCE 220 may provide a user with an indication of the camera model element that was determined to represent camera 230. As shown by reference number 535, the camera model element may be partially instantiated in the model associated with camera 230 and may be represented by dotted lines, shadowing, or other graphical affordances to indicate the model element associated with camera 230 has been identified and is awaiting indication to pair camera 230 to the model. As shown by reference number 540, TCE 220 may provide a user with an indication to pair camera 230 and the camera model element. For example, TCE 220 may provide a GUI to receive a user indication to pair camera 230 and the camera model element. As shown by reference number 545, a user may provide an indication to pair camera 230 and the camera model element. For example, a user may click a button (e.g., selecting “Yes”) on a GUI indicating a selection to pair camera 230 and the camera model element.

As shown in FIG. 5C, and by reference number 550, host device 210 may transmit a request, to pair camera 230 and the camera model element, to camera 230. As shown by reference number 555, upon receipt of this request, camera 230 may provide an indication to pair camera 230 to the camera model element. For example, camera 230 may display a GUI that allows a user to indicate whether or not camera 230 should be paired with the camera model element. As shown by reference number 560, camera 230 may receive an indication to pair camera 230 to the camera model element. For example, a user may input a selection on the camera 230 display or click a button on camera 230. As shown by reference number 565, the received indication may be transmitted to host device 210.

As shown in FIG. 5D, and by reference number 570, the transmitted indication may be received by host device 210. As shown by reference number 575, host device 210 may add the camera model element to the model, completing the pairing between camera 230 and the camera model element in the model. TCE 220 shows the camera model element paired and connected to a video processing element in the model. A user may utilize camera 230 providing data to the camera model element as an input to the video processing element in the model. In some implementations, the model element may correspond to a particular type of camera, in which case the model element may be configured to pair with the particular camera (e.g., by setting a parameter of the model element, such as a network address, a network port, or the like, which may be used to communicate with the camera).

As indicated above, FIGS. 5A-5D are provided merely as an example. Other examples are possible and may differ from what was described with regards to FIGS. 5A-5D.

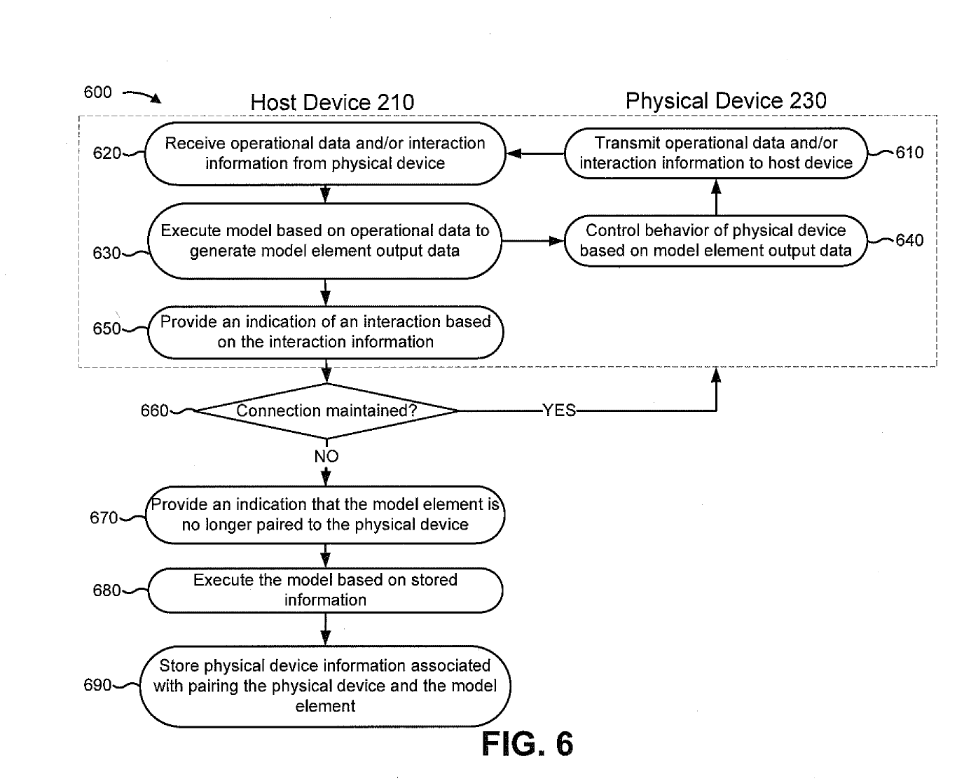

FIG. 6 is a flow chart of an example process 600 for utilizing a pairing between a physical device and a model element. In some implementations, one or more process blocks of FIG. 6 may be performed by host device 210 and physical device 230. In some implementations, one or more process blocks of FIG. 6 may be performed by another device or a group of devices separate from or including host device 210 and physical device 230, such as server device 240.

As shown in FIG. 6, process 600 may include transmitting operational data and/or interaction information to a host device (block 610). For example, physical device 230 may transmit operational data to host device 210. In some implementations, physical device 230 may transmit operational data in a manner in which the connection was established between host device 210 and physical device 230 (e.g., a wired or wireless connection).

Operational data may include data obtained, generated, stored, processed, and/or executed on physical device 230. Operational data may be pertinent to physical device 230 (e.g., a camera may transmit images) or may be indirectly pertinent to physical device 230 (e.g., the camera may transmit power and voltage consumption). Operational data may include data being obtained by physical device 230 or inherent to an operation of physical device 230. Operational data may include an input signal and/or value (e.g., the decibel values of an audio signal input to microphone), an output signal and/or value (e.g., the video signal output from a camcorder), an intermediate signal and/or value (e.g., the signal to noise ratio calculated in a signal processing unit on a sound recording device), or the like. Operational data may be associated with a particular data type (e.g., Boolean data identifying whether or not a device is powered on or off). Additionally, or alternatively, operational data may describe a behavior of physical device 230 and/or indicate an error status of physical device 230.

Interaction information may include information obtained, generated, stored, processed, and/or executed on physical device 230. Interaction information may include information relating to the spatial location of physical device 230 (e.g., three dimensional data indicating how physical device 230 is moved or manipulated in space), information relating to forces exerted on physical device 230 (e.g., data representing acceleration or force values that are applied as physical device 230 is moved or manipulated), information sensed by physical device 230 (e.g., temperature, pressure, luminosity, etc.), information relating to physical device settings or interactions with an input mechanism of physical device 230 (e.g., a switch manipulated or a button pressed), information indicating the interaction is causing a weakening or disconnection of the connection with physical device 230, or the like.

As further shown in FIG. 6, process 600 may include receiving operational data and/or interaction information from the physical device (block 620). For example, host device 210 may receive and utilize the operational data to execute the model on host device 210. In some implementations, model execution may include, but is not limited to, generating model element output data, updating input and output values associated with a model element based on data received from physical device 230 and/or updating model connections to other model elements based on data received from physical device 230.

As further shown in FIG. 6, process 600 may include executing a model based on the operational data to generate model element output data (block 630). For example, host device 210 may execute the model to generate model element output data associated with the model element and physical device 230 to which the model element is paired. Model element output data may include data calculated by the model for use as an input to physical device 230 and/or host device 210 (e.g., TCE 220). In some implementations, model element output data may be provided to physical device 230 that provided operational data used to generate the model element output data. Additionally, or alternatively, model element output data may be provided to a different physical device 230 that did not provide operational data used to generate the model element output data. Additionally, or alternatively, model element output data may be provided as an input to another model element and/or a model in TCE 220.

As further shown in FIG. 6, process 600 may include controlling a behavior of the physical device based on the model element output data (block 640). For example, host device 210 may execute a model based on operational data, and may generate model element output data to control a behavior of physical device 230. For example, a model may be executed on host device 210 after receiving RGB data (e.g., Red, Green and Blue color model data values comprising color video signal) from physical device 230 (e.g., a video camera). During model execution, the RGB data may be converted from an arithmetic representation (e.g., R=1.0; G=0.5; B=0.3) to a percentage representation (e.g., R=100%; G=50%; B=33%). The RGB data, in percentage representation, may be provided as generated model element output data to second physical device 230, for example, a display monitor requiring a color video input signal represented as RGB percentages. Additionally, or alternatively, the model element output data provided as RGB percentages may be used as an input to a separate model to control a model element representing a video camera.

In some implementations, host device 210 may execute a model based on operational data received from multiple physical devices 230. Executing the model with inputs from multiple physical devices 230 may generate model element output data that can be utilized as inputs to one or more physical devices 230 to control the behavior of the one or more physical devices 230. For example, host device 210 may execute a model based on first operational data received from a first physical device 230 (e.g., device A) and second operational data received from a second physical device 230 (e.g., device B). Host device 210 may execute the model using data received from device A and device B to generate model element output data to control a third physical device 230 (e.g., device C). For example, device A may include a microphone, device B may include a video camera, and device C may include a display monitor. Host device 210 may execute a model representing an audio/video editing system, in which device A and device B are represented by model elements inputting audio and video signals received from respective physical devices 230. Host device 210 may execute the model to generate model element output data that represents a combined audio and video signal for use as a source signal input into the display monitor (e.g., device C).

As further shown in FIG. 6, process 600 may include providing an indication of an interaction based on the interaction information (block 650). For example, host device 210 may provide an indication of an interaction based on the interaction information received from physical device 230 (e.g., an interaction indicator). In some implementations, host device 210 may alter graphical and/or textual model elements associated with physical device 230 as physical device 230 is moved, manipulated, operated, etc., by a user interacting with an input mechanism of physical device 230. For example, during model execution, visible aspects (e.g., a block size, shape, color, etc.) of the model element paired to physical device 230 may change as physical device 230 is manipulated. As an example, a model element paired to physical device 230, such as an accelerometer, may become highlighted and flash as a user manipulates the accelerometer.

Additionally, or alternatively, visible aspects of the model element paired to physical device 230 may change based on a value of interaction information and/or operational data transmitted from physical device 230. For example, a model element may change color corresponding to a value of interaction information transmitted by physical device 230. For example, a model element may receive accelerometer data, and may display in red when a relatively high value is received from the accelerometer, and may display in green when a relatively low value is received from the accelerometer.

Additionally, or alternatively, the model element paired to physical device 230 may change when interaction information and/or operational data transmitted from physical device 230 satisfies a threshold. For example, a model element may change color when interaction information transmitted by physical device 230 (e.g., an accelerometer) is above a threshold (e.g., velocity of physical device 230 is greater than three meters per second) or below a threshold (e.g., velocity of physical device is less than three meters per second). In some implementations, while the model is executing, visible aspects of the model element paired to physical device 230 may change as physical device 230 is operated to perform its designated function. For example, a model element paired to physical device 230, such as a camera, may change visible aspects (e.g., color, size, shape, etc.) as the camera is transmitting image data and the model is executed using the received image data.

Additionally, or alternatively, host device 210 may receive a user interaction associated with a model element, and may provide interaction information to physical device 230. Physical device 230 may provide an indication of the interaction based on the interaction information. For example, the user may interact with the model element (e.g., by selecting, dragging, deleting, etc. the model element). Based on the user interaction, host device 210 may provide interaction information that causes physical device 230 to provide an indication of the interaction, such as blink a light, display an interaction indicator, emit a sound, or the like.

In some implementations, a user may provide input requesting one or more indications of existing pairings. Based on such user input, host device 210 and one or more physical devices 230 may provide pairing indicators for each pairing between a model element and a physical device 230. For example, host device 210 may provide a pairing indicator associated with a first model element (e.g., may cause the first model element to flash on a user interface, to be highlighted, to be outlined, etc.), and a first physical device 230 paired to the first model element may subsequently and/or concurrently provide a pairing indicator (e.g., may blink a light, may vibrate, may display an indicator on a screen of physical device 230, etc.). The pairing indicators for the first model element and the first physical device 230 may be provided for a particular amount of time, after which host device 210 may provide a pairing indicator associated with a second model element, and a second physical device 230 paired to the second model element may subsequently and/or concurrently provide a pairing indicator. Such pairing indicators may continue to be provided until all pairings have been indicated and/or until a user provides input that causes the pairing indicators to stop being provided.

As further shown in FIG. 6, process 600 may include determining whether a connection between a physical device and a model element has been maintained (block 660). For example, host device 210 may determine if the connection between physical device 230 and host device 210 is maintained. For example, host device 210 may detect that a wired connection to physical device 230 has been disconnected. Additionally, or alternatively, host device 210 may detect that physical device 230 is out of range of a wireless connection. Host device 210 and/or physical device 230 may experience internal malfunctions producing an error state within the device that may also prohibit maintaining the connection between host device 210 and physical device 230.

If the connection is maintained (block 660—YES), then process 600 may continue execution of one or more of process blocks 610-650, as shown in FIG. 6. For example, if the connection between physical device 230 and host device 210 is maintained, physical device 230 may continue to transmit operational data and/or interaction information to host device 210 (block 610), host device 210 may continue to receive operational data and/or interaction data from physical device 230 (block 620), host device 210 may continue to execute the model based on the operational data to generate model element output data (block 630), host device 210 may continue to transmit the model element output data to physical device 230 to control a behavior of physical device 230 (block 640), and host device 210 may continue to provide an indication of an interaction based on the interaction information (block 650).

If the connection is not maintained (block 660—NO), then process 600 may include providing an indication that the model element is no longer paired to the physical device (block 670). For example, host device 210 may provide a user with an indication the model element is no longer paired to physical device 230.

In some implementations, for example in a graphical modeling environment, host device 210 may provide the indication in a GUI to indicate the model element is no longer paired to physical device 230. In some implementations, host device 210 may provide a visual affordance indicating the model element is no longer paired to physical device 230 (e.g., the previously paired model element may display an icon, flash, change color, etc.).

In some implementations, host device 210 may provide the indication as a change in the visual aspect of a model element. For example, a model element may change appearance as the connection becomes weaker, such as when physical device 230 is moving away from host device 210 and the connection is at risk of being lost. In some implementations, the intensity of the displayed model element may become progressively weaker as signal strength between physical device 230 and host device 210 decreases. Similarly, the model element may return to normal appearance as physical device 230 moves closer in proximity to host device 210, restoring the weak connection.

Additionally, or alternatively, in a graphical modeling environment, host device 210 may provide an indication that the model element is no longer paired to physical device 230 as a block in the model that is not fully operational. For example, host device 210 may gray out and/or provide a ghost block of the model element that is no longer paired. In some implementations, host device 210 may provide the indication that the model element is no longer paired to physical device 230 by representing data values in the model associated with physical device 230 with unique identifiers. For example, a model may display “No Connection,” (e.g., “NoC”) when the model element is no longer paired to physical device 230. TCE 220 may employ rules or logic to address the condition of “No Connection” (e.g., may use stored operational data, may use a default parameter value for the model element, etc.).

Additionally, or alternatively, in a textual modeling environment, host device 210 may provide the indication by highlighting a portion of code in a program representing the model to indicate the model element is no longer paired to physical device 230. In some implementations, in a textual modeling environment, host device 210 may provide the indication as an empty parameter value included in a line of code that was inserted into the model when the model element was paired with physical device 230. For example, the empty parameter value may be highlighted in the line of code to indicate the model element is no longer paired to physical device 230. Additionally, or alternatively, host device 210 may provide the indication as a GUI that may appear in a text editor component of the textual modeling environment providing the user with the indication that the model element is no longer paired to physical device 230.

In some implementations, host device 210 may provide the indication by producing a visible indication (e.g., emitting a light, emitting a light repeatedly in a blinking or flashing manner, turning off a light, changing the color of a light, etc.) on host device 210 to alert a user that the model element is no longer paired to physical device 230. In some implementations, host device 210 may provide the indication by producing an audible indication (e.g., a sound, series of sounds, etc.) on host device 210 to alert a user that the model element is no longer paired to physical device 230. In some implementations, host device 210 may provide the indication by producing a haptic and/or tactile indication (e.g., a vibration, a series of vibrations, etc.) on host device 210 to alert a user that the model element is no longer paired to physical device 230.

Additionally, or alternatively, host device 210, physical device 230 and/or TCE 220 may provide the indication by producing information such as a report, an email, or an error message to alert the user that the model element is no longer paired to physical device 230. In some implementations, an indication provided by host device 210, physical device 230 and/or TCE 220 may dynamically change over time as the connection between the model element and physical device 230 becomes unmaintainable. For example, host device 210 may provide the indication as a series of three audible tones that increase in frequency or duration as physical device 230 moves out of proximity with host device 210 and is unable to maintain the connection required for pairing the model element and the physical device.

In some implementations, the type of indication provided by host device 210 may be a specific type of indication when the model element and physical device 230 are no longer paired and the corresponding model element is associated with a particular type of physical device 230. For example, if physical device 230 was previously connected to a model element and the connection is not maintained, host device 210 may provide a unique indication to alert a user that the model element and physical device 230 are no longer paired. Additionally, or alternatively, host device 210 may provide a unique indicator for a particular class or type of physical device 230 to indicate when the model element and physical device 230 are no longer paired. For example, host device 210 and/or TCE 220, may emit a visual indication (e.g., a statically displayed or blinking light) and/or may display a graphical affordance (e.g., a window that provides an alert) when physical device 230 (e.g., a test and measurement device) is no longer paired with a model element representing physical device 230 (e.g., the test and measurement device).

In some implementations, physical device 230 may provide an indication that the model element is no longer paired to physical device 230. In some implementations, physical device 230 may provide a GUI or warning dialog on physical device 230 to indicate that the model element is no longer paired to physical device 230. In some implementations, physical device 230 may utilize sound, light, vibration, or the like to provide an indication that the model element is no longer paired to physical device 230.

As further shown in FIG. 6, process 600 may include executing the model based on stored information (block 680). For example, host device 210 (e.g., TCE 220) may execute the model using data stored from a previous pairing between host device 210 and physical device 230. The data may be located on host device 210, and/or server device 240. In some implementations, host device 210 (e.g., TCE 220) may store the model, operational data and/or interaction information associated with model execution when a new, subsequent or different type of physical device 230 has established connection. TCE 220 may provide a user with an indication that a connection has not been maintained to a first physical device 230 and may prompt the user to save the model, operational data and/or interaction information before establishing a connection with a second physical device 230. Host device 210 may access stored data to execute the model when the connection between the model element and physical device 230 has not been maintained.

In some implementations, a user may be prompted to select a replacement model element corresponding to a similar physical device 230 for substitution into the model. The replacement model element being substituted into the model may be a previous model element, a default model element, or a user-selected model element. For example, host device 210 may be configured to use a default model element when executing the model after a connection has not been maintained between a model element and physical device 230. Examples of a default model element include a null value or a generic model element representing a class of model elements associated with specific physical device 230 types.

In some implementations, host device 210 may execute the model based on substituting operational data. For example, host device 210 may execute the model utilizing operational data from a previous pairing between physical device 230 and the model element (e.g., the most recent value received by host device 210 from physical device 230). Additionally, or alternatively, host device 210 may execute the model using a default, null (e.g., zero), or calculated (e.g., average, over a particular time period, of values received from physical device 230) operational data.

Host device 210 may execute the model using a recursive filter, such as a Kalman filter, to estimate operational data values after the connection has not been maintained between a model element and physical device 230. In some implementations, host device 210 may execute the model applying logic or rules when the model element is no longer paired to physical device 230. For example, TCE 220 may execute the model that is in a state of “No Connection” with estimated operational data values determined by Kalman filter estimation.

In some implementations, host device 210 may stop and/or pause execution of the model when the connection is not maintained. Host device 210 may prompt the user to provide input identifying a substitute model element and/or substitute operational data. Host device 210 may prompt the user to identify and connect an alternate physical device 230 when the connection is not maintained. Upon receiving user input, host device 210 may continue executing the model using the substitute model element and/or operational data.

As further shown in FIG. 6, process 600 may include storing physical device information associated with pairing the physical device and the model element (block 690). For example, host device 210 may store information associated with pairing physical device 230 and the corresponding model element. In some implementations, the stored information may include a unique identifier representing a previously paired physical device 230. Additionally, or alternatively, the identifier may be based on a particular type of data provided by physical device 230. In some implementations, a user may assign an identifier to model elements to represent a prioritized list of devices, and may be provided with an interface to select from the prioritized list once a physical device 230 on the prioritized list is in proximity to establish a connection with host device 210. Additionally, or alternatively, host device 210 may store and utilize operational data and/or interaction information associated with a particular physical device 230 (e.g., device A) while a connection is maintained with device A. If a new physical device 230 (e.g., device B) establishes a connection to host device 210 and the connection to physical device A is not maintained, the operational data and/or interaction information associated with device A may be discarded and/or stored. The user may be prompted to regarding whether to begin storing and/or utilizing operational data and/or interaction information associated with device B.

Although FIG. 6 show example blocks of process 600, in some implementations, process 600 may include additional blocks, different blocks, fewer blocks, or differently arranged blocks than those depicted in FIG. 6. Additionally, or alternatively, one or more of the blocks of process 600 may be performed in parallel.

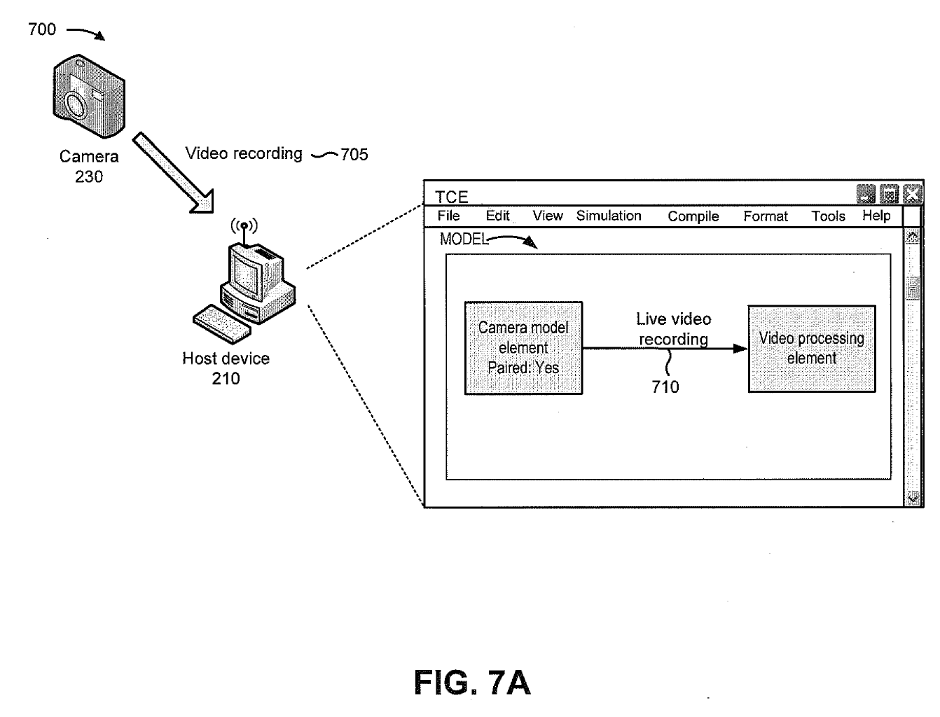

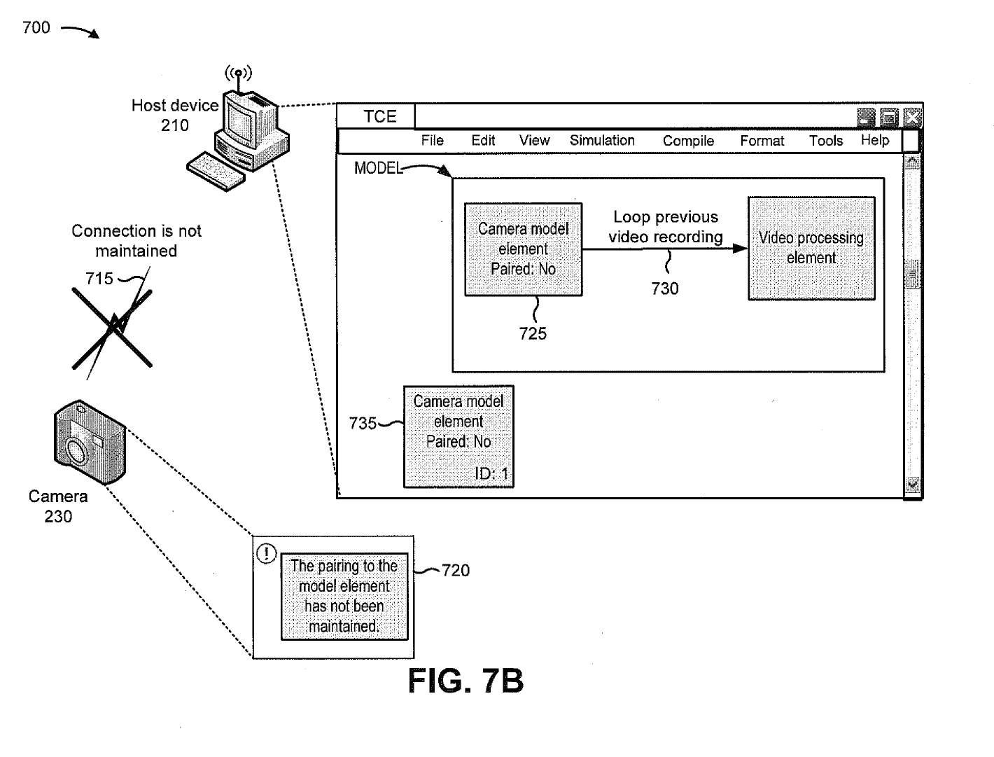

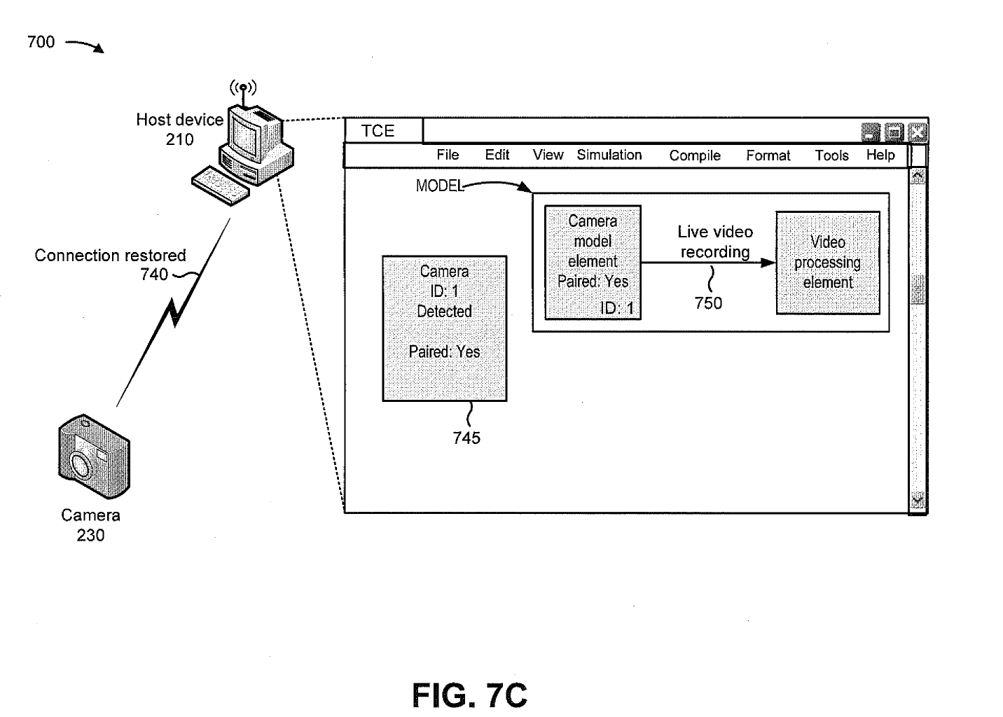

FIGS. 7A-7C are diagrams of an example implementation relating to example process 600 shown in FIG. 6. In FIG. 7A, assume camera 230 is in proximity and maintaining a connection to host device 210. As shown by reference number 705, camera 230 is transmitting live video recording data to host device 210. The camera model element is paired to camera 230 based on the connection previously established between host device 210 and camera 230. As shown by reference number 710, the camera model element is transmitting live video recording received from camera 230 to a video processing element in the model during execution of the model. Transmission of live video recording from the camera modeling element to the video processing element continues as long as the connection is maintained between host device 210 and camera 230.

As shown in FIG. 7B, and by reference number 715, assume camera 230 is moved out of range of host device 210 and the connection is not maintained. As shown by reference number 720, camera 230 may provide an indication that the model element is no longer paired to camera 230. As shown by reference number 725, host device 210 may detect the lack of connection and provide an indication in the model that the camera model element is no longer paired with camera 230. As shown by reference number 730, the model may continue to operate using a loop of previously recorded video data in place of the live video recording. The data may indicate the duration since the last time it was transmitted using visual attributes (e.g., decreasing brightness, intensity, saturation or the like). As shown by reference number 735, host device 210 may store information associated with the previously paired camera modeling element. For example, host device 210 may store an identifier of “1” (e.g., ID: 1), associated with pairing camera 230 and the model element. Stored information may be utilized when re-establishing connection and pairing between camera 230 and host device 210.

As shown in FIG. 7C, and by reference number 740, camera 230 has returned within signal range of host device 210 and re-established the connection. As shown by reference number 745, host device 210 utilizes the stored information, for example “ID: 1,” to determine the appropriate camera model element to select and pair to camera 230. As shown by reference number 750, the paired camera model element is added to the model and resumes transmitting live video recording received from camera 230 to the video processing element in the model.

As indicated above, FIGS. 7A-7C are provided merely as an example. Other examples are possible and may differ from what was described with regards to FIGS. 7A-7C.

The foregoing disclosure provides illustration and description, but is not intended to be exhaustive or to limit the implementations to the precise form disclosed. Modifications and variations are possible in light of the above disclosure or may be acquired from practice of the implementations.

As used herein, component is intended to be broadly construed as hardware, firmware, or a combination of hardware and software.

As used herein, code or program code is to be broadly interpreted to include text-based code that may not require further processing to execute (e.g., C++ code, C# code, Hardware Description Language (HDL) code, very-high-speed integrated circuits (VHSIC) HDL (VHDL) code, Verilog, Java, and/or other types of hardware or software based code that may be compiled and/or synthesized); binary code that may be executed (e.g., executable files that may directly be executed by an operating system, bitstream files that can be used to configure a programmable logic unit, field programmable gate array (FPGA), Java byte code, object files combined together with linker directives, source code, makefiles, etc.); text files that may be executed in conjunction with other executables (e.g., Python text files, a collection of dynamic-link library (DLL) files with text-based combining, configuration information that connects pre-compiled modules, an extensible markup language (XML) file describing module linkage, JavaScript Object Notation (JSON), etc.); etc. In one example, program code may include different combinations of the above-identified classes (e.g., text-based code, binary code, text files, etc.). Additionally, or alternatively, program code may include code generated using a dynamically-typed programming language (e.g., the M language, a MATLAB® language, a MATLAB-compatible language, a MATLAB-like language, etc.) that can be used to express problems and/or solutions in mathematical notations. Additionally, or alternatively, program code may be of any type, such as a function, a script, an object, etc., and a portion of program code may include one or more characters, lines, etc. of the program code.

Some implementations are described herein in conjunction with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc. Furthermore, these phrases, as used herein, may be used interchangeably.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device comprising:
one or more processors to:
detect a physical device;
establish a connection with the physical device;
receive physical device information from the physical device, based on establishing the connection with the physical device;
determine a model element associated with the physical device, based on receiving the physical device information; and
pair the physical device and the model element, based on determining the model element associated with the physical device.

2. The device of claim 1, where one or more processors are further to:
transmit a request for the physical device information; and
where the one or more processors, when receiving the physical device information are further to:
receive the physical device information based on transmitting the request.

3. The device of claim 1, where the one or more processors are further to:
execute the model element;
generate model element output data based on executing the model element; and
provide the model element output data to the physical device,
the model element output data controlling a behavior of the physical device.

4. The device of claim 1, where the one or more processors are further to:
add the model element to a model associated with the physical device, based on pairing the physical device and the model element.

5. The device of claim 4, where the one or more processors are further to:
receive operational data from the physical device, the operational data describing a behavior of the physical device; and
execute the model based on the received operational data.

6. The device of claim 4, where the one or more processors are further to:
determine that the connection has been disconnected; and
execute the model using stored information, based on determining that the connection has been disconnected.

7. The device of claim 1, where the one or more processors are further to:
receive interaction information from the physical device, the interaction information being associated with a user interaction with the physical device; and
provide an indication of the user interaction based on the received interaction information.

8. The device of claim 1, where the one or more processors are further to:
determine that the connection has been disconnected; and
provide an indication that the model element is no longer paired to the physical device, based on determining that the connection has been disconnected.

9. The device of claim 1, where the one or more processors are further to:
determine that the connection has been disconnected; and
store an identifier associated with pairing the physical device and the model element, based on determining that the connection has been disconnected.

10. A computer-readable medium storing instructions, the instructions comprising:
one or more instructions that, when executed by one or more processors, cause the one or more processors to:
detect a physical device;
receive physical device information based on detecting a physical device;
determine a model element associated with the physical device, based on receiving the physical device information;
receive an indication to pair the physical device and the model element, based on determining the model element associated with the physical device;
pair the physical device and the model element, based on receiving the indication to pair the physical device and the model element; and
add the model element to a model associated with the physical device, based on pairing the physical device and the model element.

11. The computer-readable medium of claim 10, where the one or more instructions, that cause the one or more processors to receive the indication to pair the physical device and the model element, further cause the one or more processors to:
receive the indication to pair based on a user interaction with the physical device.

12. The computer-readable medium of claim 10, where the one or more instructions, that cause the one or more processors to determine the model element associated with the physical device, further cause the one or more processors to at least one of:
search a library to identify the model element that represents the physical device, based on the physical device information; or
generate the new model element based on the physical device information.

13. The computer-readable medium of claim 10, where the one or more instructions, that cause the one or more processors to add the model element to the model associated with the physical device, further cause the one or more processors to at least one of:
add code to a program associated with the model;
add a block to a block diagram associated with the model; or
add an object to a workspace associated with the model.

14. The computer-readable medium of claim 10, where the physical device information includes at least one of:
information that identifies the physical device;
information that identifies a type of the physical device;
information associated with an input of the physical device; or
information associated with an output of the physical device.

15. A method, comprising:
establishing a connection with a physical device,
the establishing being performed by a host device;
receiving physical device information, via the connection,
the receiving the physical device information being performed by the host device;
determining a model element representing the physical device, based on receiving the physical device information,
the determining being performed by the host device;
pairing the physical device and the model element, based on determining the model element representing the physical device,
the pairing being performed by the host device;
receiving interaction information associated with the physical device,
the receiving the interaction information being performed by the host device; and
providing an indication of an interaction identified by the interaction information,
the providing being performed by the host device.

16. The method of claim 15, where the interaction comprises at least one of:
moving the physical device;
interacting with an input mechanism of the physical device; or
an interaction that causes a weakening or disconnection of the connection with the physical device.

17. The method of claim 15, further comprising:
determining that the connection has been disconnected;
receiving information that identifies a substitute model element to be used in the model in place of the model element, based on determining that the connection has been disconnected; and
executing the model using the substitute model element.

18. The method of claim 15, further comprising:
receiving operational data from the physical device, the operational data describing a behavior of the physical device; and
executing the model using the operational data.

19. The method of claim 18, further comprising:
determining that the connection has been disconnected;
receiving information that identifies substitute operational data to be used in the model in place of the operational data; and
executing the model using the substitute operational data.

20. The method of claim 19, where the substitute operational data is based on the operational data.
